(19) United States
(12) Patent Application Publication
(10) Pub. No.: US 2025/0111299 A1
(43) Pub. Date: Apr. 3, 2025

(54) SYSTEMS AND METHODS FOR SELF-SCHEDULE RECOMMENDATIONS

(71) Applicant: UKG Inc., Weston, FL (US)

(72) Inventors: Stephan Corriveau, Montreal (CA); Beyime Tachefine, Montreal (CA); Steve Menard, Montreal (CA)

(21) Appl. No.: 18/476,864

(22) Filed: Sep. 28, 2023

(51) Int. Cl. G06Q 10/0631

(52) U.S. Cl. CPC G06Q 10/063112; G06Q 10/063116

(57) ABSTRACT

Self-schedule suggestions are generated for a user. The suggestions are generated by scoring and selecting open shifts based on user preferences and selected shift features. Schedule days are scored and ranked according to criteria associated with each day. Scored open shifts are assembled into a suggested schedule by iteratively selecting the top open shifts for the top schedule days while verifying that the schedule meets regulatory or preference constraints. The self-schedule suggestions are presented to a user, and a user can accept or reject the suggestions. Rejecting suggestions can cause the regeneration of schedule suggestions using different shift features.

### BACKGROUND

Shift scheduling is a time-intensive activity for employees and managers. Automated global schedulers are often impractical due to their computational requirements and are unable to accommodate interactive real-time schedule adjustments and selections by a user.

### SUMMARY

The present disclosure provides for systems, methods, and non-transitory computer-readable media for schedule generation and embodiments thereof. As explained in greater detail herein, embodiments of the current disclosure generate schedule suggestions for a user. The schedule suggestions are generated based on ranked open shift features and ranked days. Users can review suggestions and accept, reject, or edit the suggested schedule.

As will be appreciated, the suggested schedule generation provides for efficient schedule generation. The techniques described herein improve the consistency and accuracy of schedules. The techniques described herein also improve the overall employee satisfaction with their schedule by satisfying the employee preferences and facilitating fast and efficient changes to schedules.

In some aspects, the techniques described herein relate to a computer-implemented method for schedule generation, the method including: querying a schedule database for a plurality of shift features, wherein the schedule database includes previous schedule data for a user; receiving schedule preferences for the user; assembling a first set of user shift features from the plurality of shift features and the schedule preferences; selecting a score function based on the first set of user shift features; receiving a set of open shifts for a set of days for the user; computing, for each open shift in the set of open shifts, an open shift score with the score function; sorting the set of open shifts based on the open shift scores to generate an ordered list of open shifts; assembling a first schedule for the user according to the ordered list of open shifts; and generating, for presentation at a user interface, a depiction of the first schedule.

In some aspects, the techniques described herein relate to a system, including at least one server computer including at least one processor and at least one memory, the at least one server computer configured to: query a schedule database for a plurality of shift features, wherein the schedule database includes previous schedule data for a user; receive schedule preferences for the user; assemble a first set of user shift features from the plurality of shift features and the schedule preferences; select a score function based on the first set of user shift features; receive a set of open shifts for a set of days for the user; compute, for each open shift in the set of open shifts, an open shift score with the score function; sort the set of open shifts based on the open shift scores to generate an ordered list of open shifts; assemble a first schedule for the user according to the ordered list of open shifts; and generate, for presentation at a user interface, a depiction of the first schedule.

These and other systems, methods, objects, features, and advantages of the present disclosure will be apparent to those skilled in the art from the following detailed description of the embodiments and the drawings.

### BRIEF DESCRIPTION OF THE FIGURES

The invention and the following detailed description of certain embodiments thereof may be understood by reference to the following figures:

FIG. 1 shows aspects of an example scheduling system.

FIG. 2A shows aspects of one example of a date choice panel interface.

FIG. 2B shows aspects of one example of an interface with schedule recommendations.

FIG. 2C depicts some aspects of an interface that may be provided on a user device to select and review suggested schedules.

FIG. 3 shows aspects of a process flow for identifying and scoring open shifts for schedule suggestions.

FIG. 4 shows aspects of an apparatus for identifying and scoring open shifts.

FIG. 5 shows aspects of a process flow for day rank calculation.

FIG. 6 shows aspects of a process flow for generating a suggested schedule.

FIG. 7 shows aspects of a process flow in response to user acceptance or rejection of a suggested schedule.

FIG. 8 is a flowchart of an example method 800 for generating schedule suggestions.

### DETAILED DESCRIPTION

Employee shift scheduling is a computationally difficult problem. Computing a schedule for all employees may require significant computation time using large computational resources. Given its complexity, it is often impractical, if not impossible, to accommodate employee changes as they may trigger complete time-intensive computations.

In many cases, to facilitate employee input, organizations forgo automated methods and rely on manual schedule creation. Manual schedule creation requires an employee to build their schedule by hand, picking open shifts for each day. Manual methods, while providing an ability to accommodate employee selections, are a tedious, time-consuming, repetitive, and error-prone process.

The techniques described herein introduce an auto-generation of an employee (also referred to as a user herein) schedule. A proposed schedule may be generated for each user with consideration of the user's preferences and/or shift features. An employee is presented with the auto-generated schedule and is given the ability to accept, edit, or reject the schedule.

The techniques described herein improve the flexibility of a scheduler and reduce the time and cost required to reconfigure or adjust a schedule to accommodate user changes. The techniques described herein enable automated and, in many cases, real-time generation of schedules. The techniques described herein improve the consistency and accuracy of schedules. The techniques described herein also improve the overall employee satisfaction with their schedule by satisfying the employee preferences and facilitating fast and efficient changes to schedules. The techniques described herein reduce or eliminate user entry errors that may conflict with user preferences and/or laws and regulations. The techniques described herein provide an improvement to the operations of a computer and scheduling system by reducing the time and processing required to generate and update a schedule.

The techniques described herein can be applied to any type of schedule and organization. The examples described herein may include descriptions of a shift schedule but those skilled in the art will appreciate that the techniques may be adapted to other types of schedules. In one implementation, the schedule suggestions are generated for each day for a user. Day-based schedule recommendations may help the employee select the best open shift they can work on a given day without overwhelming the user with too many options or data. In this mode, the recommendation system may recommend two or more of the best (highest scoring) shifts an employee can work on a given date considering the rest of their schedule. In another implementation, the schedule suggestions are generated for a time period (i.e., a week, a month, etc.). In period-based scheduling, the system may build and suggest a complete employee schedule for the requested period. In this mode, the recommendation functionality can be configured to present to the employee a first recommendation the self-schedule, allow the employee to modify the recommended schedule (i.e., to reject it completely or partially), and request the system to generate a new suggestion that considers the current state of the employee schedule.

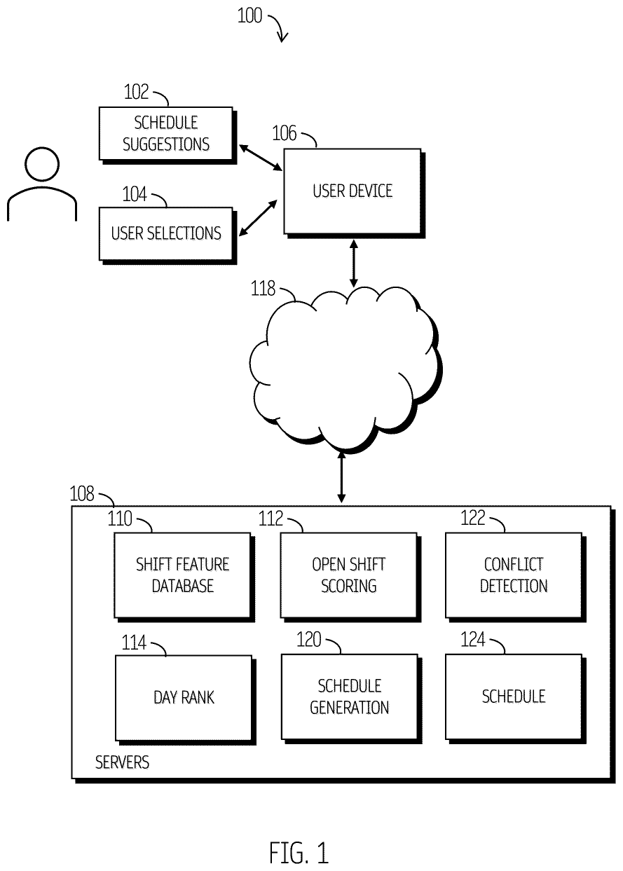

FIG. 1 shows aspects of an example system 100 that uses techniques described herein. In one example, system 100 may be configured to generate schedule suggestions 102 and provide the schedule suggestions 102 to a user via a user device 106. The user may review the schedule suggestions 102 and may edit or modify the suggestions 102 with user selections 104. In FIG. 1, the user may generate a schedule generation request from user device 106. In some implementations, schedules may be generated in response to a log-in by the user, in response to the user selecting an element in the UI to generate the schedule. In some implementations, a schedule may be generated according to an execution mode defined by a system administrator or manager, and the system can generate the schedule suggestions in batch mode at designated times and notify a user when the schedule suggestions are ready for review. In some implementations, a suggested schedule may be pushed to the user and may not require a request from a user. User device 106 may be any appropriate computing device, such as a computer, tablet, or phone. User device 106 may be running any appropriate software to allow user to view and manipulate a schedule.

In some implementations, the system may include one or more components on one or more servers 108 configured to generate and/or modify a schedule for a user. The server 108 may receive one or more user selections 104. The user selections may include a user identifier, schedule preferences, and the like. The servers 108 may include components to maintain and generate user schedules 124. Schedule suggestions may be generated using a schedule generator 120 using one or more elements such as a shift feature database 110, open shift scoring component 112, day rank component 114, and a conflict detection component 122 which are further described herein.

In some implementations, user device 106 may generate suggested schedules using installed software in a standalone manner (i.e., elements 110, 112, 114, 120, and 122 may be part of the user device 106). In some implementations, user device 106 may use a service provided over a network connection. For example, user device 106 may use network 118 to access one or more servers 108 that can execute the components to generate a schedule suggestion.

In embodiments, the system may track selected suggestions and determine the differences with the requested schedules. System 100 may further allow the user to rate the recommended schedule and use employee feedback to improve the quality of the recommendations. In some implementations, the system may recommend two or three schedule suggestions and allow employees to compare the options.

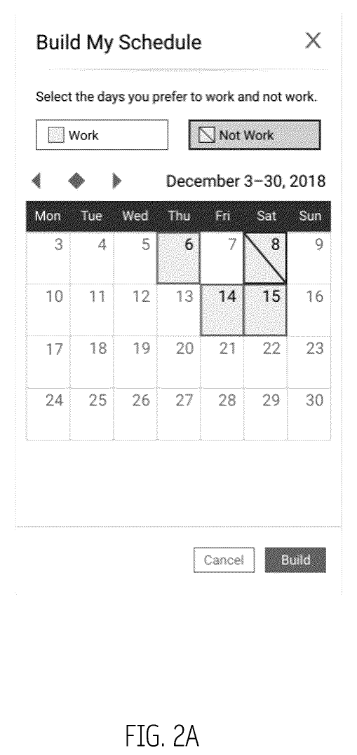

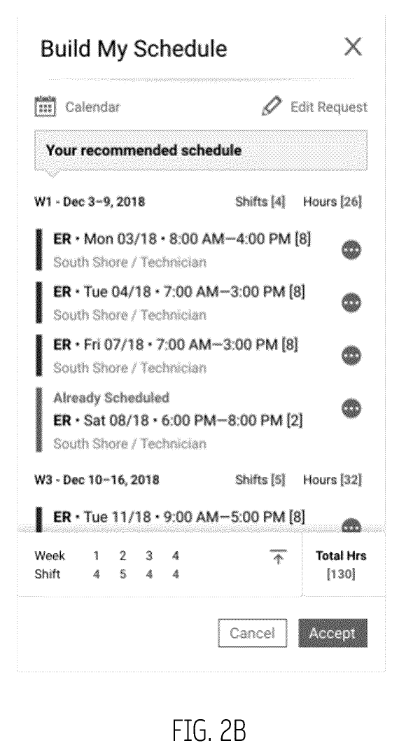

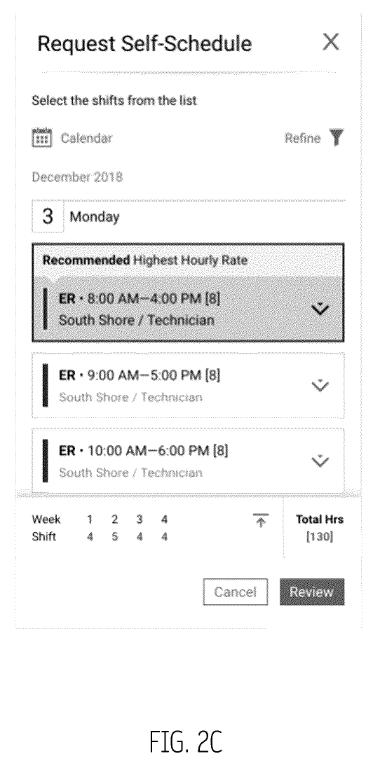

FIGS. 2A-2C depict some aspects of an interface that may be provided on a user device to select and review suggested schedules. In one implementation, a user may enable schedule suggestions and may be presented with a choice panel interface to select one or more dates for which they would like to be scheduled. FIG. 2A shows aspects of one example of a date choice panel interface. The date choice panel interface may include a depiction of a calendar allowing the user to select one or more days, weeks, or other periods for scheduling. The user may specify days they will not be scheduled (depicted as “Not Work” days). User selections of days or periods may be constrained by schedule period constraints defined by the employer or a regulatory agency. For example, users may be restricted as to the maximum number of days they can be scheduled in a row or the number of consecutive days they request not to be scheduled. In some implementations, users may specify recurring patterns for workdays (i.e., no work on Mondays each week), and the patterns may be automatically extended or populated for future scheduled days. In some implementations, the schedule days may be automatically populated based on workday requirements, historical data, days that have open shifts, assignments from managers, and the like. In some implementations, the choice panel interface may prepopulate days that the user is already scheduled for as workdays. After the days are selected, the user may select to build the schedule. Selecting the build button may cause the user device to request the system to generate a suggested schedule. Once a response is received, the user device may populate an interface with the suggested schedule. Generation of suggested schedules may occur in response to a request and a suggested schedule may be transmitted to the user in seconds. In some cases, the suggested schedule may be generated in batch mode and may be generated at a later time. In the case of batch mode generation, the system may transmit an alert to the user device indicating that the suggested schedule in ready for user review.

FIG. 2B shows aspects of one example of an interface with schedule recommendations generated by the system 100. In one implementation, the suggested schedule may be shown as a chronological list. The interface may include data identifying the number of shifts scheduled in the recommendations, the total number of hours scheduled in the recommendations, and the like. Visualizations of the schedule recommendations may include work times, location, role, and the like. The schedule suggestions may show the top-rated shift for the user based on user preferences and shift features. The user may have the option to accept the suggested schedule. Accepting a suggested schedule may cause the suggested schedule to be committed as the user's active schedule. In some implementations, when a user selects an option to accept the schedule, the suggested schedule may be checked for conflict with other schedules that may have changed between the time the suggested schedule was generated and the time the user accepted the schedule. In some implementations, the suggested schedule may be associated with an expiration date that limits the time the user has to consider and accept a schedule.

In the case of scheduling conflicts, after a schedule is accepted, the system may regenerate the suggested schedule and present the user with a new suggested schedule. In some implementations, the whole schedule may be regenerated. In some cases, the parts of the schedule that do not have conflicts may be committed as the active schedule, and only the parts of the schedule with conflicts may be regenerated.

The interface with schedule recommendations shown in FIG. 2B may include an option to edit one or more of the schedule recommendations. FIG. 2B shows aspects of an example interface for editing recommendations. In one implementation, the interface may be configured to edit a schedule suggestion for a day. The edit interface may show additional options (when available) for open shifts for a selected day. The open shifts may be sorted according to their rank or score that was computed during the suggested schedule generation. The interface may include a description of a feature of each shift, such as “highest hourly rate” or “night shift” (where applicable) to aid the user with another selection. The edit interface of FIG. 2C may allow the user to select a different shift or suggest their own and add the change to the suggested schedule, at which point the interface can return to the interface shown in FIG. 2B.

In embodiments, the generation of schedule suggestions may include one or more processes for identifying and scoring open shifts, identifying and scoring open workdays, and assembling a schedule based on the scored open shifts and the scored open workdays.

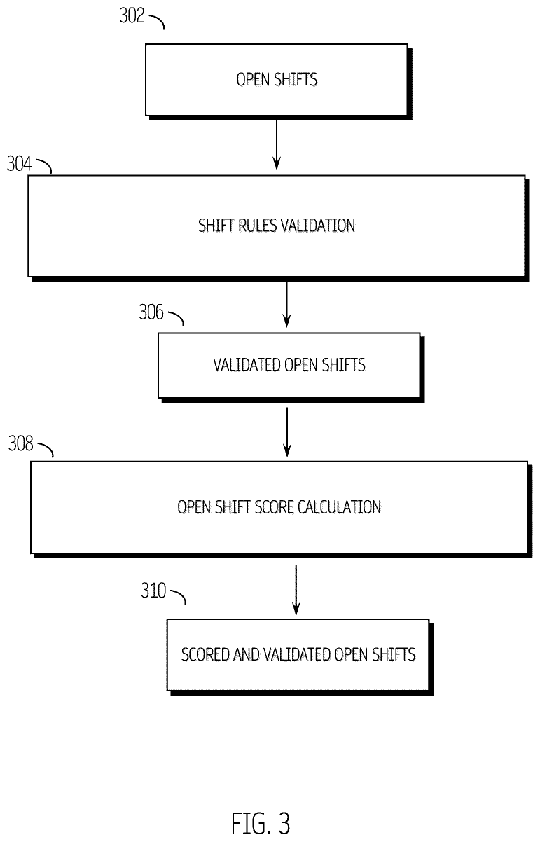

FIG. 3 shows aspects of a process flow for identifying and scoring open shifts for schedule suggestions. The process may receive a set of open shifts 302. The set of open shifts 302 may be identified from a set of shift that are not scheduled from an employer schedule. The set of open shifts 302 may be processed by a shift rules validation module 304 to generate a set of validated open shifts 306. The shift rules validation module 304 may be configured to evaluate each open shift 302 against the applicable scheduling rules (such as occurrence, break length, etc.) for the employee. The set of validated open shifts 306 may be further processed with an open shift score calculation module 308 to generate a set of scored and validated open shifts 310 for the user.

In embodiments, the open shift score calculation module 308 may score open shifts based on a set of user preferences and/or a set of shift features. In one example, the set of preferences and/or shift features may include elements such as: similarity of skills and certifications (employee has skills and certifications the shift requires), hours (employee often works more hours than other employees), co-worker affinity (shift is concurrent with another which a usual co-worker is working), schedule history day frequency (shift occurs a day employee usually work), schedule history job (shift is for a job employee often works), schedule history location (shift is in place employee usually work the most), schedule history time of day (shift occurs in a day “zone” employee often work), and the like. The score for each open shift may be determined using a function of the set of preferences and/or the set of shift features. In one example, a function may be a weighted sum function where each element of the sum is representative of each feature or preference. In some embodiments, not all preferences and/or features may be reflected in a function. In some implementations, features may be selected based on a rating of features from the user and/or a measure of the statistical contribution of the feature to a selection of a schedule by a user (i.e., how often schedules that used the feature were selected by a user). In some implementations, the top 5 or the top 10 features may be used in scoring.

The process executed by the open shift score calculation module 308 may be expressed with the following algorithm:
For each s in S_{vd}

Cₛ=calculateOpenShiftScore(e,s)
Sort S_{vd} in descending order of Cₛ
Select and return the open shifts with highest score

Wherein:
_{d}: represents the day of the open shift selection,
e: represents the employee,
S_{d}: represents the set of open shifts available for the day d,
S_{dv}: represents the subset of open shifts assignable to the employee,
s: represents an open shift, s∈S_{d},
Cₛ: calculated score for the open shift s, measuring employee preferences satisfaction,
calculateOpenShiftScore: function that computes the score for each shift based of a set of configurable features described herein.

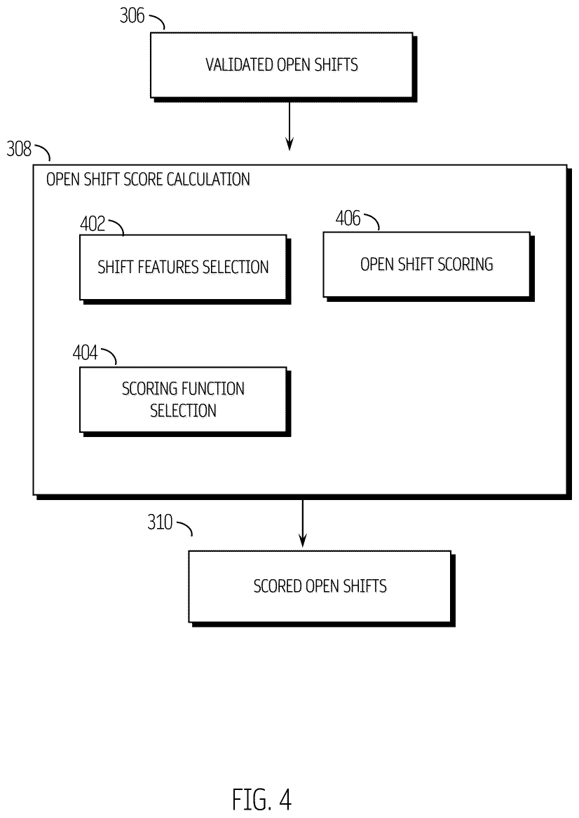

FIG. 4 shows aspects of an apparatus for identifying and scoring open shifts. In embodiments, an open shift score calculation module 308 may receive a set of validated open shifts 306 and output a set of scored and validated open shifts 310. The open shift score calculation module 308 may include an element for shift feature selection 402. Shift feature selection 402 may identify the set of available shift features and preference features and select a subset that may be used to calculate the score for each open shift. In one example, the shift feature selection 402 may be based on system settings such as a maximum number of features. The maximum number of features may be set in view of computation resource availability. In another example, the shift feature selection 402 may be based on the historical impact of each feature on the selection of a suggested schedule by a user. Any appropriate statistical method may be used to determine an impact score for each feature.

The open shift score calculation module 308 may include an element for scoring function selection 404. Scoring function selection 404 may identify appropriate function and/or function parameters for determining a score using the selected shift features. In one example, function selection may be based on computation resource availability. In another example, the function selection may be based on the historical impact of each function or the weights of each function on the selection of a suggested schedule by a user. Any appropriate statistical method may be used to determine an impact score for each feature. The open shift score calculation module 308 may further include an element for open shift scoring 406. The open shift scoring 406 element may calculate a score for each open shift based on the selected features and the scoring function.

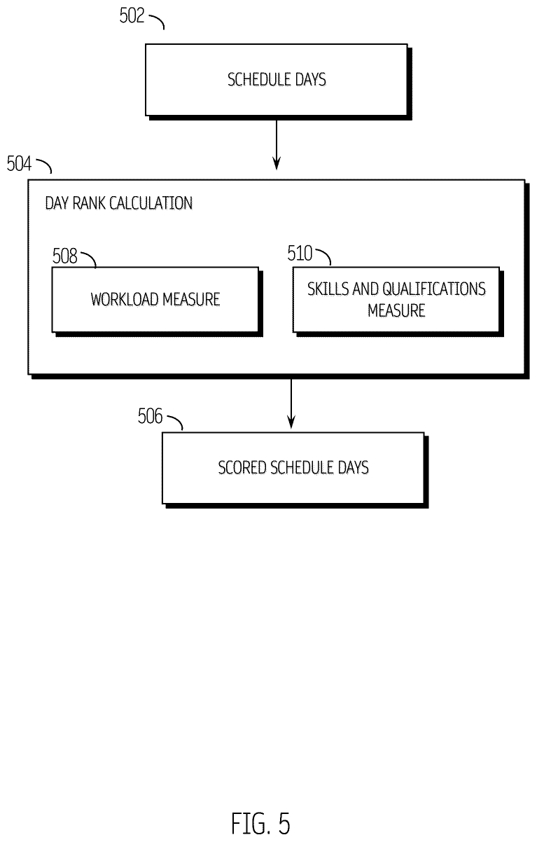

FIG. 5 shows aspects of a process flow for day score calculation. The process may receive a set of schedule days 502. In one example, the set of scheduled days 502 may be selected via a user interface such as the interface depicted in FIG. 2A. The set of schedule days 502 may be processed by a day rank calculation module 504 to generate a set of scored schedule days 506. In some implementations, the day rank calculation may include a workload measure module 508. The workload measure module 508 may score each open day based on worker demand for each day. In one example, the workload measure module may calculate a score based on the number of open shifts available daily. In some implementations, the day rank calculation may include a skills and qualifications measure module 510. The skills and qualifications measure module 510 may be configured to calculate a rank for a day based on the probability that the available open shifts are only assignable to the employee (i.e., due to skills and qualifications requirements). The set of scored schedule days 506 may be calculated using one of the workload measure modules 508 or skills and qualifications measure module 510.

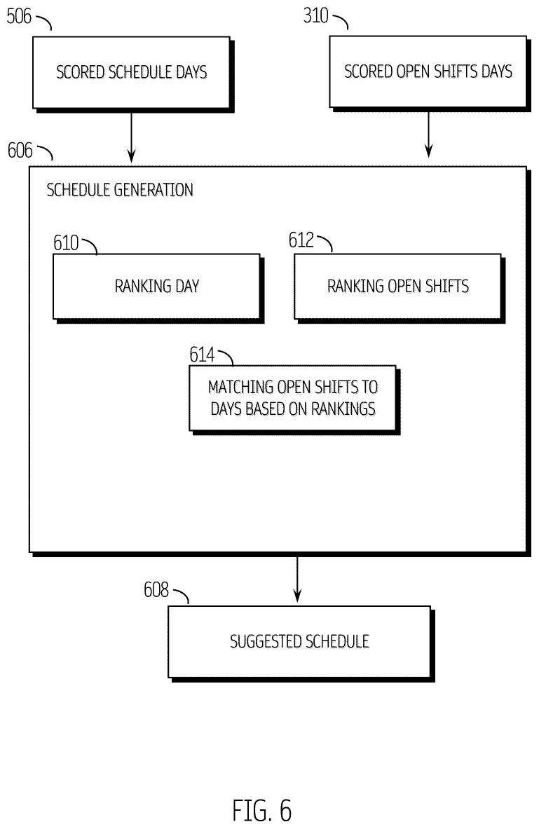

FIG. 6 shows aspects of a process flow for generating a suggested schedule 608. A schedule generator 606 may be configured to generate the suggested schedule 608 using the set of scored schedule days 506 and the set of scored and validated open shifts 310. In some implementations, schedule generation 606 may include ranking the set of scored schedule days 610 and ranking the set of set of scored and validated open shifts 612. In embodiments, ranking may be based on the score of each set. Ranking may include sorting each set based on the score assigned to each set element. Schedule generator 606 may further include a process for matching open shifts to open days based on the ranking 614. Process 614 may determine a schedule by selecting a first day (the top-ranked day) from the ordered list of days and assign the first open shift (the top-ranked open shift) that corresponds to the first day. After the first (top-ranked) day is assigned an open shift, the process my continue to the second day on the list (second-ranked day) and select the top ranked open shift that corresponds to the day. The process may continue until all the days are assigned open shifts.

The process executed by the schedule generator 606 and day rank calculation module 504 may be expressed with the following algorithm:
For each d in P_{w}

r_{d}=calculateDayRank(d)

P_{w}^{ranked}=sort(P_{w}) in descending order of r_{d}
ES: employee schedule initialized with the already assigned shifts
for each d in P_{w}^{ranked}
   s=OSRA (d): select the best shift using the open shift recommender algorithm.
ES←S
return ES++

wherein:
P: represents the set of days composing the self-schedule period,
P_{off}: represents the set of off days requested by the employee plus the days where the employee is already scheduled for work, and
P_{w}: represents the days to be scheduled. P−P_{off}.

and wherein calculateDayRank(d) can be implemented using one of the two following options:
Option 1: Assign first on days with high demand:

$${r}_{d} = \vert {S}_{d} \vert - th e number of open shifts available for a day is a good indicator of the level of workload .$$

Option 2: Assign first on days with high probability that the available open shifts are only assignable to the current employee (skills & qualifications):

$${r}_{d} = 1 - \frac{{\sum }_{s ∈ {S}_{d}^{v}} ( \frac{{n}_{s}}{N} )}{\vert {S}_{d}^{v} \vert}$$

where N: total number of employees working in the same location and nₛ=number of employees who can work the open shift s.

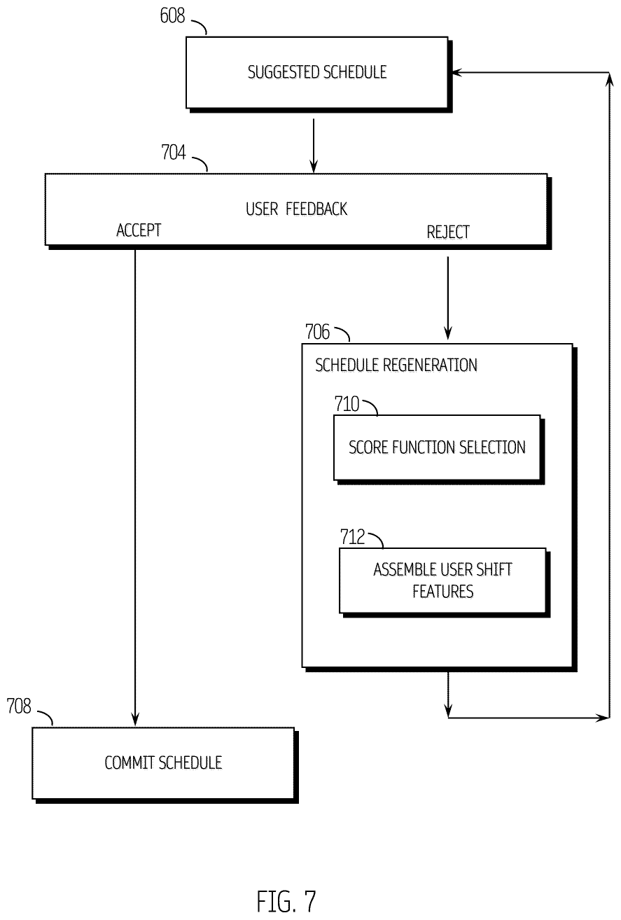

FIG. 7 shows aspects of a process flow in response to user acceptance or rejection of a suggested schedule. In embodiments, a suggested schedule 608 may be accepted or rejected via user feedback 704. User feedback 704 may be received from an interface from a user device such as the interface depicted in FIG. 2B. An acceptance of a suggested schedule may cause the suggested schedule to be committed as the active schedule 708. A rejection of a suggested schedule may cause schedule regeneration 706. In implementations, a schedule may be regenerated using different score functions and/or shift features. In embodiments, schedule regeneration 706 may include assembly of new user shift features 712 and/or selection of new score function 710. Assembly of new shift features may include removing or adding shift features from previous calculations of suggested schedules. Selection of new score functions may include adjusting the weights of functions.

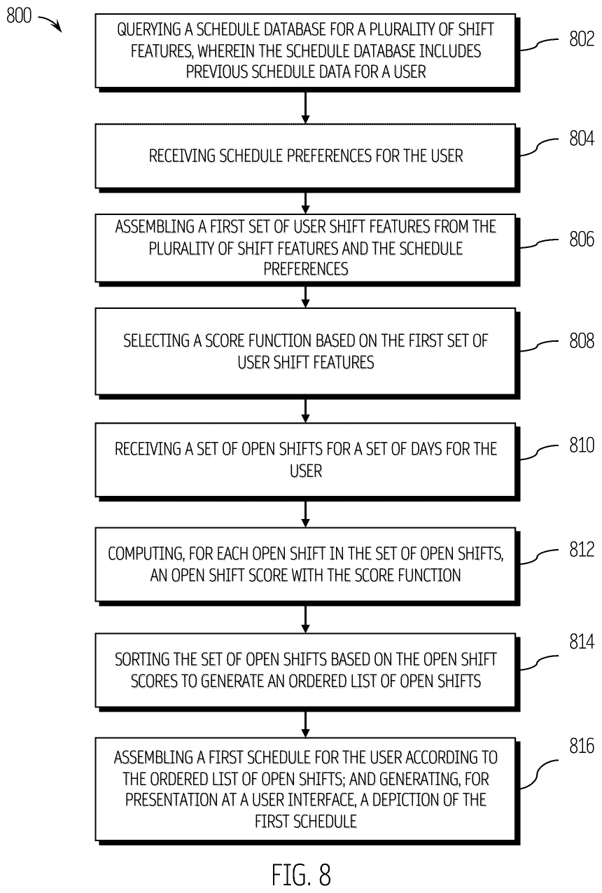

FIG. 8 is a flowchart of an example method 800 for generating schedule suggestions. In one example, method 800 may be implemented by the systems and structures described with respect to FIGS. 3-7. At step 802, the method may include querying a schedule database for a plurality of shift features. In embodiments, the schedule database may include previous schedule data for a user, and the schedule features may be derived from the historical data. At step 804, the method may include receiving schedule preferences for the user. Preferences may be received from a user device and/or a schedule database from a server. At step 806, the method may include assembling a first set of user shift features from the plurality of shift features and the schedule preferences. Assembly of the shift features may be based on the historical success of features in resulting in schedule selection. At step 808, the method may include selecting a score function based on the first set of user shift features. Selecting a score function may be based on the historical success of functions resulting in schedule selection.

At step 810, the method may include receiving a set of open shifts for a set of days for the user. At step 812, the method may include computing, for each open shift in the set of open shifts, an open shift score with the score function. At step 814, the method may include sorting the set of open shifts based on the open shift scores to generate an ordered list of open shifts. At step 816, the method may further include assembling a first schedule for the user according to the ordered list of open shifts and generating, for presentation at a user interface, a depiction of the first schedule.

In embodiments, assembling a first schedule may further include generating an ordered list of days from the set of days. The ordering may be a form a ranking of the days and may be based on a demand of a day and/or based on skills and qualifications requirements for a day. Generating the schedule may include matching the top-ranked day with the top-ranked open shifts for each day.

One or more certain further aspects of the example systems, apparatuses, and methods are described following, any one or more of which may be incorporated in certain embodiments.

In some aspects, the techniques described herein relate to a computer-implemented method for schedule generation, the method including: querying a schedule database for a plurality of shift features, wherein the schedule database includes previous schedule data for a user; receiving schedule preferences for the user; assembling a first set of user shift features from the plurality of shift features and the schedule preferences; selecting a score function based on the first set of user shift features; receiving a set of open shifts for a set of days for the user; computing, for each open shift in the set of open shifts, an open shift score with the score function; sorting the set of open shifts based on the open shift scores to generate an ordered list of open shifts; assembling a first schedule for the user according to the ordered list of open shifts; and generating, for presentation at a user interface, a depiction of the first schedule.

In some aspects, the techniques described herein relate to a method, further including transmitting an alert to a user device, wherein the alert indicates that the first schedule is ready for review.

In some aspects, the techniques described herein relate to a method, wherein assembling the first schedule for the user includes: generating an ordered list of days from the set of days; selecting a first day from the ordered list of days; and selecting from the ordered list of open shifts a first open shift that corresponds to the first day.

In some aspects, the techniques described herein relate to a method, wherein assembling the first schedule for the user includes: selecting a second day from the ordered list of days; and selecting from the ordered list of open shifts a first open shift that corresponds to the second day.

In some aspects, the techniques described herein relate to a method, wherein generating the ordered list of days includes: ordering the set of days according to a number of open shifts available for each day.

In some aspects, the techniques described herein relate to a method, wherein generating the ordered list of days includes: calculating a day score for each day in the set of days based on at least one of a skill or a qualification of the user; and ordering the set of days according to the day score.

In some aspects, the techniques described herein relate to a method, further including: receiving a selection indicative of acceptance of the first schedule by the user; and committing the first schedule for the user.

In some aspects, the techniques described herein relate to a method, further including: receiving a selection indicative of rejection of the first schedule by the user; assembling a second set of user shift features from the plurality of shift features and the schedule preferences; selecting a second score function for the second set of user shift features; computing, for each open shift in the set of open shifts, a second open shift score with the second score function; sorting the set of open shifts based on the second open shift scores to generate a second ordered list of open shifts; assembling a second schedule for the user according to the second ordered list of open shifts; and generating, for presentation at the user interface, a depiction of the second schedule.

In some aspects, the techniques described herein relate to a method, further including: receiving a selection indicative of acceptance of the first schedule by the user; detecting a scheduling conflict in the first schedule with a schedule of a second user; and receiving a second set of open shifts for a set of days for the user; computing, for each open shift in the second set of open shifts, a second open shift score with the score function; sorting the second set of open shifts based on the second open shift scores to generate a second ordered list of open shifts; assembling a second schedule for the user according to the second ordered list of open shifts; and generating, for presentation at the user interface, a depiction of the second schedule.

In some aspects, the techniques described herein relate to a method, wherein the plurality of shift features includes at least one of user work location history, user co-worker affinity, user workday frequency, open shift skill and certification requirements, or user time of day work frequency.

In some aspects, the techniques described herein relate to a method, wherein the score function includes a weighted sum function.

In some aspects, the techniques described herein relate to a system, including at least one server computer including at least one processor and at least one memory, the at least one server computer configured to: query a schedule database for a plurality of shift features, wherein the schedule database includes previous schedule data for a user; receive schedule preferences for the user; assemble a first set of user shift features from the plurality of shift features and the schedule preferences; select a score function based on the first set of user shift features; receive a set of open shifts for a set of days for the user; compute, for each open shift in the set of open shifts, an open shift score with the score function; sort the set of open shifts based on the open shift scores to generate an ordered list of open shifts; assemble a first schedule for the user according to the ordered list of open shifts; and generate, for presentation at a user interface, a depiction of the first schedule.

In some aspects, the techniques described herein relate to a system, wherein the at least one server computer is configured to transmit an alert to a user device, wherein the alert indicates that the first schedule is ready for review.

In some aspects, the techniques described herein relate to a system, wherein assembling the first schedule for the user includes: generating an ordered list of days from the set of days; selecting a first day from the ordered list of days; and selecting from the ordered list of open shifts a first open shift that corresponds to the first day.

In some aspects, the techniques described herein relate to a system, wherein assembling the first schedule for the user includes: selecting a second day from the ordered list of days; and selecting from the ordered list of open shifts a first open shift that corresponds to the second day.

In some aspects, the techniques described herein relate to a system, wherein generating the ordered list of days includes: ordering the set of days according to a number of open shifts available for each day.

In some aspects, the techniques described herein relate to a system, wherein generating the ordered list of days includes: calculating a day score for each day in the set of days based on at least one of a skill or a qualification of the user; and ordering the set of days according to the day score.

In some aspects, the techniques described herein relate to a system, wherein the at least one server computer is configured to: receive a selection indicative of acceptance of the first schedule by the user; and commit the first schedule for the user.

In some aspects, the techniques described herein relate to a system, wherein the at least one server computer is configured to: receive a selection indicative of rejection of the first schedule by the user; assemble a second set of user shift features from the plurality of shift features and the schedule preferences; select a second score function for the second set of user shift features; compute, for each open shift in the set of open shifts, a second open shift score with the second score function; sort the set of open shifts based on the second open shift scores to generate a second ordered list of open shifts; assemble a second schedule for the user according to the second ordered list of open shifts; and generate, for presentation at the user interface, a depiction of the second schedule.

In some aspects, the techniques described herein relate to a system, wherein the at least one server computer is configured to: receive a selection indicative of acceptance of the first schedule by the user; detect a scheduling conflict in the first schedule with a schedule of a second user; and receive a second set of open shifts for a set of days for the user; compute, for each open shift in the second set of open shifts, a second open shift score with the score function; sort the second set of open shifts based on the second open shift scores to generate a second ordered list of open shifts; assemble a second schedule for the user according to the second ordered list of open shifts; and generate, for presentation at the user interface, a depiction of the second schedule.

In some aspects, the techniques described herein relate to a system including: an open shift calculation circuit configured to: query a schedule database for a plurality of shift features, wherein the schedule database includes previous schedule data for a user, receive schedule preferences for the user, assemble a first set of user shift features from the plurality of shift features and the schedule preferences, and select a score function based on the first set of user shift features; a day rank calculation circuit configured to: receive a set of open shifts for a set of days for the user, compute, for each open shift in the set of open shifts, an open shift score with the score function, and sort the set of open shifts based on the open shift scores to generate an ordered list of open shifts; and a schedule generation circuit configured to: assemble a first schedule for the user according to the ordered list of open shifts; and generate, for presentation at a user interface, a depiction of the first schedule.

In some aspects, the techniques described herein relate to a system, wherein the schedule generation circuit is further configured to transmit an alert to a user device, wherein the alert indicates that the first schedule is ready for review.

In some aspects, the techniques described herein relate to a system, wherein assembling the first schedule for the user includes: generating an ordered list of days from the set of days; selecting a first day from the ordered list of days; and selecting from the ordered list of open shifts a first open shift that corresponds to the first day.

In some aspects, the techniques described herein relate to a system, wherein assembling the first schedule for the user includes: selecting a second day from the ordered list of days; and selecting from the ordered list of open shifts a first open shift that corresponds to the second day.

In some aspects, the techniques described herein relate to a system, wherein generating the ordered list of days includes: ordering the set of days according to a number of open shifts available for each day.

In some aspects, the techniques described herein relate to a system, wherein generating the ordered list of days includes: calculating a day score for each day in the set of days based on at least one of a skill or a qualification of the user; and ordering the set of days according to the day score.

In some aspects, the techniques described herein relate to a system, wherein the schedule generation circuit is further configured to: receive a selection indicative of acceptance of the first schedule by the user; and commit the first schedule for the user.

In some aspects, the techniques described herein relate to a system, wherein: the schedule generation circuit is further configured to: receive a selection indicative of rejection of the first schedule by the user; the open shift calculation circuit is further configured to: assemble a second set of user shift features from the plurality of shift features and the schedule preferences; select a second score function for the second set of user shift features, compute, for each open shift in the set of open shifts, a second open shift score with the second score function, and sort the set of open shifts based on the second open shift scores to generate a second ordered list of open shifts; and the schedule generation circuit configured to: assemble a second schedule for the user according to the second ordered list of open shifts, and generate, for presentation at the user interface, a depiction of the second schedule.

In some aspects, the techniques described herein relate to a system, wherein: the schedule generation circuit is further configured to: receive a selection indicative of acceptance of the first schedule by the user, and detect a scheduling conflict in the first schedule with a schedule of a second user; and the open shift calculation circuit is further configured to: receive a second set of open shifts for a set of days for the user, compute, for each open shift in the second set of open shifts, a second open shift score with the score function, and sort the second set of open shifts based on the second open shift scores to generate a second ordered list of open shifts; the schedule generation circuit is further configured to: assemble a second schedule for the user according to the second ordered list of open shifts, and generate, for presentation at the user interface, a depiction of the second schedule.

In some aspects, the techniques described herein relate to a system, wherein the plurality of shift features includes at least one of user work location history, user co-worker affinity, user workday frequency, open shift skill and certification requirements, or user time of day work frequency.

In some aspects, the techniques described herein relate to a system, wherein the score function includes a weighted sum function.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general-purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g., where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

What is claimed is:

1. A computer-implemented method for schedule generation, the method comprising:
querying a schedule database for a plurality of shift features, wherein the schedule database includes previous schedule data for a user;
receiving schedule preferences for the user;
assembling a first set of user shift features from the plurality of shift features and the schedule preferences;
selecting a score function based on the first set of user shift features;
receiving a set of open shifts for a set of days for the user;
computing, for each open shift in the set of open shifts, an open shift score with the score function;
sorting the set of open shifts based on the open shift scores to generate an ordered list of open shifts;
assembling a first schedule for the user according to the ordered list of open shifts; and
generating, for presentation at a user interface, a depiction of the first schedule.

2. The method of claim 1, further comprising transmitting an alert to a user device, wherein the alert indicates that the first schedule is ready for review.

3. The method of claim 1, wherein assembling the first schedule for the user comprises:
generating an ordered list of days from the set of days;
selecting a first day from the ordered list of days; and
selecting from the ordered list of open shifts a first open shift that corresponds to the first day.

4. The method of claim 3, wherein assembling the first schedule for the user comprises:
selecting a second day from the ordered list of days; and
selecting from the ordered list of open shifts a first open shift that corresponds to the second day.

5. The method of claim 4, wherein generating the ordered list of days comprises:
ordering the set of days according to a number of open shifts available for each day.

6. The method of claim 4, wherein generating the ordered list of days comprises:
calculating a day score for each day in the set of days based on at least one of a skill or a qualification of the user; and
ordering the set of days according to the day score.

7. The method of claim 1, further comprising:
receiving a selection indicative of acceptance of the first schedule by the user; and
committing the first schedule for the user.

8. The method of claim 1, further comprising:
receiving a selection indicative of rejection of the first schedule by the user;
assembling a second set of user shift features from the plurality of shift features and the schedule preferences;
selecting a second score function for the second set of user shift features;
computing, for each open shift in the set of open shifts, a second open shift score with the second score function;
sorting the set of open shifts based on the second open shift scores to generate a second ordered list of open shifts;
assembling a second schedule for the user according to the second ordered list of open shifts; and
generating, for presentation at the user interface, a depiction of the second schedule.

9. The method of claim 1, further comprising:
receiving a selection indicative of acceptance of the first schedule by the user;
detecting a scheduling conflict in the first schedule with a schedule of a second user; and
receiving a second set of open shifts for a set of days for the user;
computing, for each open shift in the second set of open shifts, a second open shift score with the score function;
sorting the second set of open shifts based on the second open shift scores to generate a second ordered list of open shifts;
assembling a second schedule for the user according to the second ordered list of open shifts; and
generating, for presentation at the user interface, a depiction of the second schedule.

10. The method of claim 1, wherein the plurality of shift features comprises at least one of user work location history, user co-worker affinity, user workday frequency, open shift skill and certification requirements, or user time of day work frequency.

11. The method of claim 1, wherein the score function comprises a weighted sum function.

12. A system, comprising at least one server computer comprising at least one processor and at least one memory, the at least one server computer configured to:
query a schedule database for a plurality of shift features, wherein the schedule database includes previous schedule data for a user;
receive schedule preferences for the user;
assemble a first set of user shift features from the plurality of shift features and the schedule preferences;
select a score function based on the first set of user shift features;
receive a set of open shifts for a set of days for the user;
compute, for each open shift in the set of open shifts, an open shift score with the score function;
sort the set of open shifts based on the open shift scores to generate an ordered list of open shifts;
assemble a first schedule for the user according to the ordered list of open shifts; and
generate, for presentation at a user interface, a depiction of the first schedule.

13. The system of claim 12, wherein the at least one server computer is configured to transmit an alert to a user device, wherein the alert indicates that the first schedule is ready for review.

14. The system of claim 12, wherein assembling the first schedule for the user comprises:
generating an ordered list of days from the set of days;
selecting a first day from the ordered list of days; and
selecting from the ordered list of open shifts a first open shift that corresponds to the first day.

15. The system of claim 14, wherein assembling the first schedule for the user comprises:
selecting a second day from the ordered list of days; and
selecting from the ordered list of open shifts a first open shift that corresponds to the second day.

16. The system of claim 15, wherein generating the ordered list of days comprises:
ordering the set of days according to a number of open shifts available for each day.

17. The system of claim 15, wherein generating the ordered list of days comprises:
calculating a day score for each day in the set of days based on at least one of a skill or a qualification of the user; and
ordering the set of days according to the day score.

18. The system of claim 12, wherein the at least one server computer is configured to:
receive a selection indicative of acceptance of the first schedule by the user; and
commit the first schedule for the user.

19. The system of claim 12, wherein the at least one server computer is configured to:
receive a selection indicative of rejection of the first schedule by the user;
assemble a second set of user shift features from the plurality of shift features and the schedule preferences;
select a second score function for the second set of user shift features;
compute, for each open shift in the set of open shifts, a second open shift score with the second score function;
sort the set of open shifts based on the second open shift scores to generate a second ordered list of open shifts;
assemble a second schedule for the user according to the second ordered list of open shifts; and
generate, for presentation at the user interface, a depiction of the second schedule.

20. The system of claim 12, wherein the at least one server computer is configured to:
receive a selection indicative of acceptance of the first schedule by the user;
detect a scheduling conflict in the first schedule with a schedule of a second user; and
receive a second set of open shifts for a set of days for the user;
compute, for each open shift in the second set of open shifts, a second open shift score with the score function;
sort the second set of open shifts based on the second open shift scores to generate a second ordered list of open shifts;
assemble a second schedule for the user according to the second ordered list of open shifts; and
generate, for presentation at the user interface, a depiction of the second schedule.
